(19) United States
(12) Patent Application Publication
(10) Pub. No.: US 2002/0144282 A1
(43) Pub. Date: Oct. 3, 2002

(54) Personalizing CE equipment configuration at server via web-enabled device

(75) Inventor: Jan Van Ee, Cupertino, CA (US)

Correspondence Address: Philips Electronics North America Corporation, 580 White Plains Road, Tarrytown, NY, 10591, US

(73) Assignee: KONINKLIJKE PHILIPS ELECTRONICS N.V.

(21) Appl. No.: 09/823,658

(22) Filed: Mar. 29, 2001

(51) Int. Cl. G06F 3/00; H04N 5/445; G06F 13/00; H04N 7/173

(52) U.S. Cl. 725/109; 725/46

(57) ABSTRACT

The configuring of CE equipment by the consumer is facilitated by means of delegating the configuring to an application server on the Internet. The consumer enters his/her preferences in a specific interactive Web page through a suitable user-interface of an Internet-enabled device, such as a PC or set-top box or digital cellphone. The application server generates the control data based on the preferences entered and downloads the control data to the CE equipment itself or to the Internet-enabled device.

### FIELD OF THE INVENTION

The invention relates in particular to the user-programmability, user-controlled configuring or setting-up of consumer audio/video (A/V) equipment.

### BACKGROUND ART

Consumer electronics (CE) equipment, such as audio/video (A/V) apparatus or a home theater, are typically meant for entertainment or simple communication, all without the user having to interact with an intricate menu through a sophisticated and versatile user-interface such as comes with a desktop PC or laptop PC.

The play-out and recording of content information received via, e.g., a TV set, has become user-programmable through electronic program guides (EPG's). The content information can be time-shifted, time-warped, and edited through recording equipment such as the Personal TV recording system developed by TiVo. As a result, the TV screen has been transformed from being only an entertainment screen to a programming user-interface. The programming user-interface lets the user set up the configuration and personalization of the content information. Typically, the user has to enter answers to questions presented on the TV screen, clicking through menus, selecting options, typing keywords (with a remote for control of a jumping highlight in an array of alphanumeric characters) and much more.

A typical scenario for installing a TiVo unit is the following. After connecting the unit to a TV set, an extensive setup menu appears on the TV's display monitor for enabling the user to program the unit according to geographic location in order to get the correct TV guide information. After that the unit starts an initialization procedure to generate a local database and all the embedded information in order to start its new life as the user's Personal TV (PTV). In the meantime, the user can boot his PC and connect to the Internet for registering the TiVo unit at the www.tivo.com web-site, where the user has to enter the unit's serial number and the user's credit information. Upon completion of the initialization procedure the user programs the unit via the remote control and creates its first “to-do”-list: a list of TV programs he/she would like to have recorded on the unit's hard disk drive (HDD).

### SUMMARY OF THE INVENTION

The inventor has realized that configuring customizable A/V equipment, e.g., the TiVo unit, personalized music jukeboxes, high-end TV sets, Internet-enabled consumer appliances, etc., via the equipment itself has disadvantages from the end-user's point of view. The user-interface of the known equipment itself is typically neither intended nor optimized for extensive programming, unlike that of a PC. For example, there are too many options in too many screens for being selected in a convenient manner by the user through the apparatus' limited user-interface. As another example, entering a string of alphanumerical characters, e.g., the ZIP code of the geographical service area, into the selection menu of the TiVo unit is done in a rather cumbersome manner: the selection of each character is to be made through jumping highlights in an array of characters. The highlight is controlled via arrow buttons on a remote.

Such programming or configuring of the A/V equipment is typically done only once before it is ready for daily usage. The equipment's main functionality is supplying, playing out, or rendering content information, especially for entertainment. Providing a specific programming interface for functionalities used only once, in addition to the interface for daily operation, increases the costs, causes confusion with the end-user, and requires real-estate at the control panel. These aspects are going to get even worse if the number of options and additional services increases.

The inventor therefore proposes to set up and program the equipment, e.g., the PTV unit, directly from a web-site accessed through another Internet enabled system that does have an appropriate user-interface. This results in a PTV unit not needing all those fancy screens and difficult personalization options. The unit then is a simple box with a simple remote control that can be easily used.

A scenario for configuring the PTV unit then includes the following steps. The unit is connected to a TV set and to a telephone line. Next, the user uses a PC (or an Internet Appliance such as a Web Companion, or a set top box, or a digital cellphone) to register the box with the www.philips-personal-tv.com website via the serial number and a credit card. After registering, the user is led to a “My Personal TV” Web page that is interacted with through the PC, Internet appliance, set-top box or digital cellphone. These apparatus typically have an appropriate user interface for menu selection and text entry (e.g., mouse, keyboard). This page offers the option to teach the system which content the user likes. Similar to what, e.g., Amazon.com is doing with book and music selections, the user can rate TV programs, movies, movie stars, topical subjects, etc. This page can be linked to the user's Amazon.com profile, so that every DVD movie the user orders will improve the accuracy of his/her PTV system. This personal page also provides the local TV Guide. Here the user can make selections of the programs he/she wants to have stored on the HDD of the PTV unit. When finished, the user presses the “Create the to-do list”-button. After that the user returns to the TV set and switches on the PTV unit. The unit dials-out to the Internet via a 1-800 number, logs in with its serial number into the philips-personal-tv.com website and downloads the to-do list. It also downloads the local access phone-number, since it needs this when it dials-out again (every 4 hour) to refresh its memory. A “refresh”-button on the remote control will enforce an immediate download of a new “to-do”-list. Also, every refresh operation causes the table of content of the HDD to be communicated back to the web-site, so that the user is able to do file management (delete shows not needed any more) from this personalized web-site as well.

With this web-centric PTV system, all the personalization and programming is done at the server on the Internet. The PTV unit only gets a “to-do”-list with channel and program-start and program-stop information, “delete”-commands, etc. The PTV unit only needs to have a simple operating system with a TCP/IP stack. The only fancy screens needed are a kind of programming guide for the content on the disk and for the live channels.

Advantages of the invention are manifold. The PTV unit costs are much lower due to less development time, less memory and lower complexity. The personalization software does not reside at the unit but resides on the Internet, as a result of which the environment and the UI (user interface) can be easily changed to adapt to new user requirements. This personalization technology is readily available. The service provider or manufacturer can build a web-site taking into account user-demographics, which can become a very powerful Internet tool for advertisement and other service-related and targeted activities. The TV display monitor has become an entertainment screen again, since all cumbersome setup and programming (i.e., lean-forward activities) are done via a system which is much better equipped for doing that (e.g., having high-resolution screen, keyboard). The consumer is able to program his/her PTV unit from anywhere in the world. The Consumer can even program his PTV unit from a Philips Internet-connected GSM phone (WAP protocol).

What has been explained above with regard to a PTV also applies to other user-configurable A/V systems such as high-end TV's, HDD-based music jukeboxes, etc. These systems are Internet-enabled themselves in order to get the configuration data directly downloaded from the server. Alternatively, these user-configurable A/V systems are equipped with a data input to receive the configuration data via another system that in turn got the data downloaded from the server.

What has been explained with regard to the Internet is also applicable to other (public) networks, such as the data network of America On Line, or via an ordinary telephone line.

In summary, the method of the invention enables a consumer to program a first consumer electronics system for operation according to preferences specified by the consumer. The consumer interacts via a network with an application on a server. The server generates control data to program the first system according to the preference as specified by the consumer in the interaction. Preferably, user-interaction with the server for specifying the preferences is achieved via a second system of the consumer that has a more appropriate user-interface for entering text-based information and for navigating among menu options. For example, the WebTV set top box manufactured by Philips Electronics comes with a wireless alphanumeric keyboard and is highly suitable fore this kind of interaction. The control data can be downloaded from the server directly into the first system or into a another (the second or yet another) system of the consumer. In the latter case, the control data is to be transferred from the other system to the first system.

The user-group that is characterized by being ‘non-PC initiated’, although probably as interested as any to watch what they want when they want, would be deprived of these features. The service is therefore preferably extended with a call center that one can interface to with an ordinary telephone. The service provides a human operator, a touch-tone driven menu or a speech-recognition driven menu for initiating the programming or setting up of the configuration based on the caller's input, e.g., by entering the specifications into the server through human intervention or automatically via the menu. The control data thus generated are then delivered, e.g., retrieved via the network if the first consumer electronics system is network-enabled, or mailed on a diskette or memory card to the consumer for transfer to the first system.

Yet another advantageous aspect of the current invention relates to the user's programming or re-programming of his/her CE equipment from a remote location. For example, the user is on a business trip and away from home. The user has brought in his/her luggage a laptop PC or a palmtop PC that has a browser. The user now can contact the application server and send a request to the server in order to have the server tell the PTV in the CE equipment to start recording a particular show. In the known system of TiVo, for example, the PTV unit contacts the server and that only once daily, usually at night. In the invention, the user is enabled to contact the server and submit a request to the server to contact a specific PTV unit for a specific purpose, e.g., to program the PTV unit so that it records a show that is going to be on the air within minutes. Thus, the application server not only is a facilitating system for configuring the home network, but it also enables the user to access the home network for other purposes, e.g., programming, verification of the programmed state, changing of the programming or the configuration, etc., at the time the user wants and from any location that is convenient to the user. In summary, the consumer interacts with the server through the second system from a location remote from the first system. The consumer can request the server to establish contact with the first system and the server establishes the contact in response to the consumer's request.

The application server can be part of a server system such as “SmartConnect” (TM) of Philips Electronics. This SmartConnect (TM) server system maintains a user profile of a particular end-user who has registered his/her CE equipment, network-enabled and not network-enabled, with the server. The server maintains a data base of new technical features for this type of equipment. If there is a match between the user-profile and a new technical feature, and the user indicates to receive information about updates or sales offers, the user gets notified via the network of the option to obtain the feature. The server can also detect possible synergies, for example, by the server having access to an inventory of devices and capabilities on a user's home network. The inventory is, for example, a look-up service as provided by a HAVi or Jini architecture. The server has also access to a data base with information of features for a network. The server determines if the synergy of the apparatus present on the user's network can be enhanced based on the listing of the inventory and on the user's profile. If there are features that are relevant to the synergy, based on these criteria, the user gets notified. For example, the user has been registered as owning a Pronto universal programmable remote control device manufactured by Philips Electronics. When the user now registers the PTV unit and subscribes to the EPG and other services, the application server suggests to the user to have the Pronto's configuration updated so as to have an icon on the LCD screen associated with the PTV, and the PTV's IR control codes stored.

Using the application server to orchestrate the configuration of the user's home network also allows the user to enter his/her profile data (name, address, etc.) only once, and to have the server use it if and when additional apparatus is purchased by the user. See, e.g., U.S. Ser. No. 09/464,866 (Attorney docket PHA 23,884) incorporated by reference and discussed below in further detail. That is, the server has a data base with information relating to the consumer and acquired prior to the interaction with the server to program or configure the current system. The generation of the control data now takes into account the information in the data base. For example, the user does not have to enter his/her name and address again.

### BRIEF DESCRIPTION OF THE DRAWINGS

The invention is explained in further detail and by way of example with reference to the accompanying drawing wherein:

FIGS. 1, 2 and 3 are block diagrams of systems in the invention.

Throughout the drawings, same reference signs indicate similar or corresponding features.

### DETAILED EMBODIMENTS

The invention relates to a method of enabling a consumer to program a first consumer electronics system for operation according to a preference of the consumer, e.g., the selective supply of content information. According to the invention, the consumer is enabled to interact via the Internet with an application on a server for setting up the configuration based on the consumer's preferences entered. Control data is being created at the server based on the consumer's preferences and is then downloaded from the server to the first system for setting the configuration. The first system can be the same system through which the consumer supplies his/her preferences to the server. In that case, the first system preferably has a suitable user-interface, e.g., for convenient entering of alphanumeric characters. Delegating the creation of control data to a dedicated application server has the advantages mentioned earlier. If a second Internet enabled system, different from the first system, is being used for user-interaction with the application server for entering user-preferences, the first device does not need a dedicated user-programming interface and corresponding data input devices, and can be even less expensive and user-friendly. If the first system is Internet-enabled it can receive the control data from the server directly. Alternatively, the first system can receive the control data via the second or yet another Internet enabled system. The first system then does not require any software or hardware for Internet access for the purpose of retrieving the control data from the server. The first consumer electronics system comprises, for example, an A/V system, a PTV, an audio jukebox, a high-end television set, or even a complete home theater or home entertainment system.

The programming of the desired operation of the first system relates to selective processing of content information, e.g., selecting content information from an electronic program guide or through a search engine accessed via the application server. The desired operation may also relate to setting functional parameters of the play-out functionalities of the first system, e.g., aspect ratio of the image on a display monitor, the hue, brightness, contrast, or focus (e.g., of a projection television apparatus), bass, treble, and surround-sound parameters, etc.

The first system comprises, for example, a PTV, a high end TV receiver, a projection TV, an audio jukebox, a home theater, etc. The second system comprises for example a set-top box; a PC; a digital telephone.

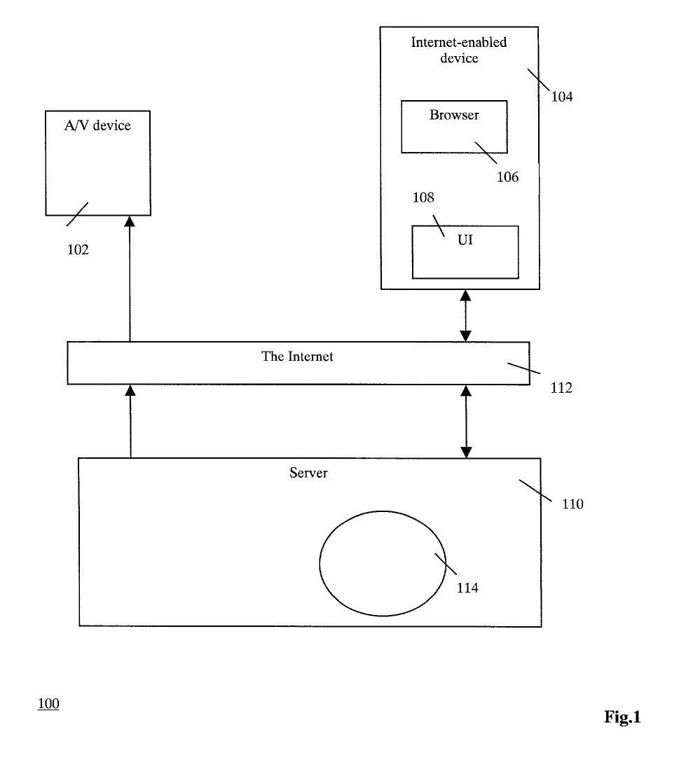

FIG. 1 is a block diagram of a system 100 in the invention. System 100 comprises an Internet-connectable user-configurable A/V sub-system 102, e.g., a PTV unit, and an Internet-enabled interactive sub-system 104, e.g., a PC or set-top box, that has a browser 106 and a user-interface 108. UI 108 comprises, for example, a display monitor, a (optionally wireless) keyboard and a mouse to allow the user to interact with a Web page, e.g., by entering alphanumeric text, clicking on hyperlinks and setting preferences in a check box.

A/V system 102 and interactive system 104 are connected to a server 110 via the Internet 112. Server 110 has an application program 114 that lets the user specify his/her desired configuration of A/V system 102 through text and/or mouse input via a specific Web site. Application program 114 creates configuration control data for A/V system 102 based on the user input. When the user has completed specifying the desired configuration, the configuration data is being generated at server 110 for being downloaded via the Internet 112 to A/V system 102. A/V system 102 comprises a controller 116 that processes the configuration data so as to configure or program A/V system 102 according to the specifications as originally supplied by the consumer. The creation of configuration or programming data that is being carried out locally on the TiVo unit has thus been delegated in the invention to application server 110, whereas the entering of user-preferences has been delegated to interactive system 104.

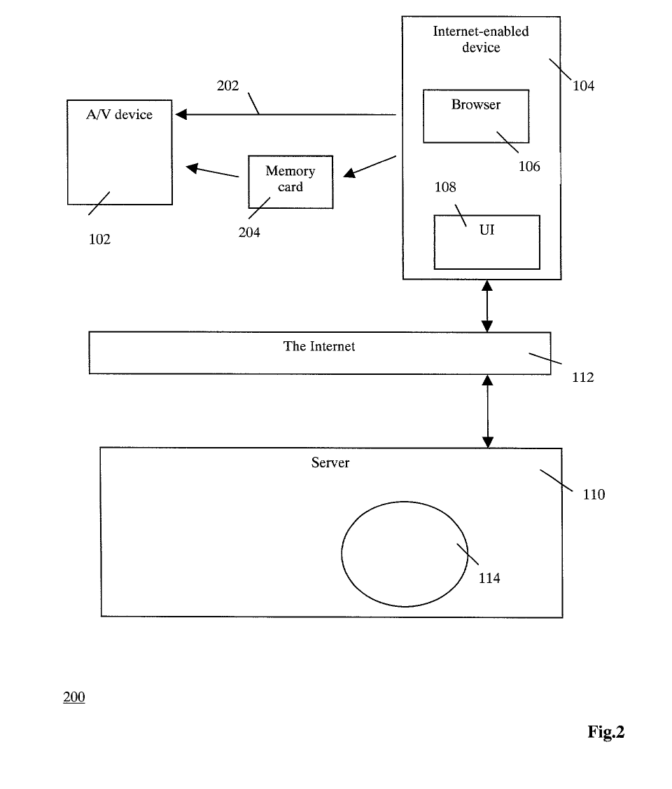

FIG. 2 is a block diagram of a system 200 to illustrate another embodiment of the method in the invention. In system 100, both sub-systems 102 and 104 have Internet access. In system 200, only system 104 has Internet access so that the control data is received by system 104. The control data is thereupon transferred from system 104 to system 102, e.g., by a wired or wireless connection 202, or through a storage medium 204 such as a diskette of a memory card.

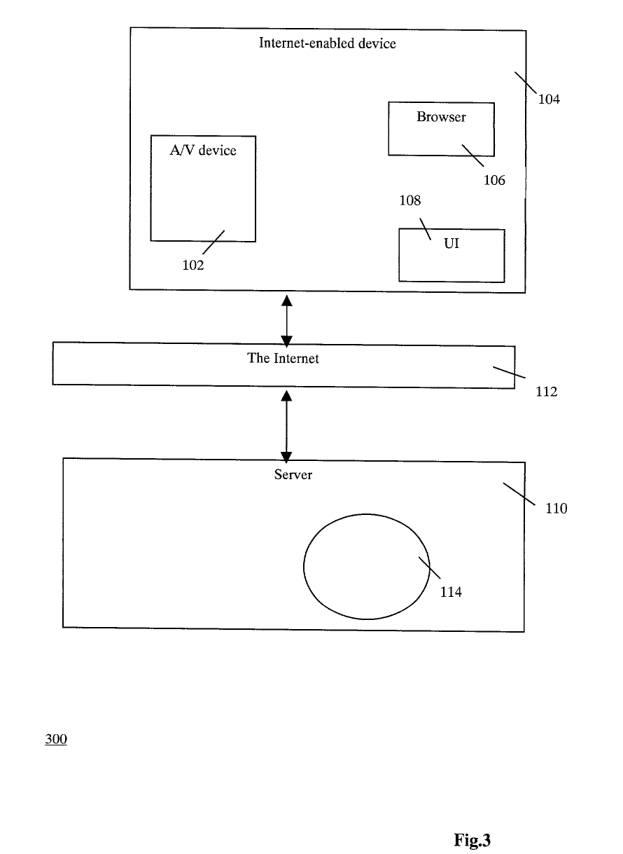

FIG. 3 is a block diagram of a system 300 to illustrate yet another embodiment of the invention. In system 300, first and second systems 102 and 104 are integrated in a combination apparatus 302. For example, a set-top box and a PTV unit, or a set-top box and an MP3 music jukebox are combined within a same CE apparatus. Both such combination apparatus comprise CE functionalities and do not present themselves to the consumers as PC's or intricate computers. The set-top box allows the user to interact via the Internet and the PTV unit or music jukebox controls the supply or storage of desired audio/video content information or audio content information, respectively.

In another example, the server is accessed via a set top box that the user interacts with through, e.g., a handheld or arm-held device such as a Web Pad. A Web pad allows the consumer to connect to the Internet either wirelessly or through a wireless connection to a home network node or a PC. The Web Pad has the form factor of a flat display monitor, e.g., an LCD with touch screen or graphical tablet.

The enabling of the consumer to configure or program a sub-system via an application server is preferably a service provided by, e.g., the retailer, the manufacturer or the importer. The generation of control data to determine the configuration or programming of the end-users home entertainment system or home theater is delegated to a specific server on the Internet. The end-user only needs to interact with this server via an appropriate UI that is not required to be a functional part of the piece of equipment that is the user is to program, set up or configure.

Herein incorporated by reference are the following patent documents for background information:

U.S. Ser. No. 09/326,506 (attorney docket PHA 23,417) filed Jun. 4, 1999 for Pieter van der Meulen for VIRTUAL JUKEBOX. This document relates to, among other things, a collection management system, or virtual jukebox. The system forms a part of a network that includes storage media and playback devices, and provides an easy to use system for collection cataloging, archiving, and retrieval. In a preferred embodiment, a collection management system resides on a CE device, or a personal or home computer (PC), and the collection includes recordings that are stored on one or more hard drives associated with the CE device or the PC. The collection management system includes a user interface that facilitates the retrieval of recordings for playback from one or more storage devices, based on an individual selection of genre, author, and so on. By storing the recordings on a hard disc drive or other mass storage device with an associated disk operating system, immediate access is available to each recording on the drive, and additional drives can be added to the system as new material is added to the collection.

U.S. Ser. No. 09/283,545 (attorney docket PHA 23,633) filed Apr. 1, 1999 for Eugene Shteyn for TIME- AND LOCATION-DRIVEN PERSONALIZED TV. This document relates to a server system that enables a subscriber to select a specific broadcast program for recording and a specific location and time frame for play-out of the recorded program.

U.S. Ser. No. 09/160,490 (attorney docket PHA 23,500) filed Sep. 25, 1998 for Adrian Turner et al., for CUSTOMIZED UPGRADING OF INTERNET-ENABLED DEVICES BASED ON USER-PROFILE. This document relates to a SmartConnect (TM) server system that maintains a user profile of a particular end-user of consumer electronics network-enabled equipment. The server also maintains a data base of new technical features for this type of equipment. If there is a match between the user-profile and a new technical feature, and the user indicates to receive information about updates or sales offers, the user gets notified via the network of the option to obtain the feature.

U.S. Ser. No. 09/189,535 (Attorney docket PHA 23,527) filed Nov. 10, 1998 for Eugene Shteyn for UPGRADING OF SYNERGETIC ASPECTS OF HOME NETWORKS. This document relates to a server that has access to an inventory of devices and capabilities on a user's home network. The inventory is, for example, a look-up service as provided by HAVi or Jini architecture. The server has also access to a data base with information of features for a network. The server determines if the synergy of the apparatus present on the user's network can be enhanced based on the listing of the inventory and on the user's profile. If there are features that are relevant to the synergy, based on these criteria, the user gets notified.

U.S. Ser. No. 09/349,676 (attorney docket PHA 23,681) filed Jul. 8, 1999 for Kristen Ondeck for AFTER-SALES CUSTOMIZATION SPECIFIED BY RETAILER ACTS AS INCENTIVE. This document relates to a machine-implemented method of doing business to stimulate commercial activities. A customer notifies a manufacturer or a dedicated service provider, of the purchase of merchandise from a specific retailer. Upon being notified, the manufacturer or service provider customizes a portal or home page for the customer by temporarily adding an advertisement banner associated with the retailer.

U.S. Ser. No. 09/311,128 (Attorney docket PHA 23,501) filed May 13, 1999 for Joost Kemink for INTERNET-BASED SERVICE FOR UPDATING A PROGRAMMABLE CONTROL DEVICE. This document relates to providing an Internet-based service for updating or customizing a programmable control device. An Internet site contains links to appliance-dependent control and feature option information which can be downloaded to the programmable control as a graphic user interface (GUI). A user interface is provided at the site for the user to easily specify a target appliance, and thereafter selectively download the interface and control information that is available for the target appliance. The Internet site also contains links to other providers of configurations and macros, such as system integrators who provide interfaces based on an inventory of the user's controllable equipment, hobbyist who share configurations and macros that they've found useful, and so on.

U.S. Ser. No. 09/464,866 (Attorney docket PHA 23,884) filed Dec. 16, 1999 for Richard Sagar for SHARED ADDRESS-DATA SERVICE FOR PERSONAL CE EQUIPMENT. This document relates to a method of transferring or enabling to transfer information in a first database of a first electronic apparatus to a second apparatus. The information is for operational use of both first and second apparatus. According to the method the information is uploaded from the first apparatus to a server, preferably via the Internet. The uploaded information is manipulated at the server. The manipulation comprises, for example, filtering and format conversion. The manipulated information is downloaded from the server, e.g., via the Internet, to the second apparatus for storage in a second data base of the second apparatus. Preferably, the first apparatus has a first communications capability and the second apparatus has a second communications capability. For example, the first apparatus comprises a PDA (Personal Digital Assistant) with an email capability or a pager, and the second apparatus comprises a mobile phone or a wired phone. The first and second data bases relate to first and second communications directories, with, e.g., names of persons, their dates of birth, their telephone and fax numbers, their street addresses, their email addresses, etc. In another example, the first and second apparatus comprises first and second PDA's or first and second mobile phones that use such contact data bases of different formats. Using the Internet as the node to which the data is uploaded has several advantages over the prior art. Note that an Internet service provider or telephony service provider could offer a facility according to the invention in order to improve their quality of service. A first advantage relates to distribution to multiple clients. Once the data has been uploaded to the Internet server it can more easily and selectively be downloaded to multiple clients, with the necessary conversion to different formats. Moreover, the formats for the various clients can be changed as time goes on, without affecting the software on the original device. It is easier because the need to connect the source device to each of the clients is removed. The Internet server can store a copy of the data for an indefinite period, as well as track which clients have had an updated copy of the data. Therefore next time a client requests the data, i.e., next time it connects to the Internet, the appropriate update is sent. This reduces the likelihood that the user “forgets” to update the data on one particular client, as could be the case if they had to connect the original device to each of the clients manually: a labor intensive task which would only be done for the purpose of updating. The chance of users using obsolete data is therefore reduced. Another advantage relates to minimizing overhead of device storage, power and maintenance. The process of converting the data from one format to another has a software overhead for the necessary conversion algorithms, processing power overhead for the conversion and storage overhead for the resulting output data file. One might imagine that for each output format supported the client has to double the available space on the device, in order to store the outputted version of the database (temporarily) until the intended recipient is connected. There is an additional problem with the originating device performing the conversion. As indicated earlier, most devices use a proprietary format for the storage of data internally, as they can in this way optimize the format of the data to their software. This could mean that the memory required in the originator increases proportionate to the number of client devices that the manufacturer wishes to support and provide data format conversion. Because most devices use mask-programmed read only memory (ROM) for program storage (as it is none-volatile, low cost and easy to mass produce), it would mean the list of conversion formats would be fixed to those that existed at the time that the source device was designed. The alternative would be to increase the cost and software complexity of the device, to allow for storage of the whole code, or at least extensions to it, to be stored in some form of re-writeable storage (EPROM or FLASH). Whenever software is delivered to an end user, there is a per user cost for the maintenance. Firstly, the cost and time overhead for delivering the software to the client and secondly, the need to install the software on the clients machine. By performing the conversion of the data on the server, only one piece of software needs to be updated. This means that all users use the same software version and same conversion algorithms, reducing versioning problems and issues with support. Yet another advantage relates to the simplicity of connection. It is not always possibly to directly connect two pieces of equipment together. Consider a cellular phone. Often these devices have a hardware interface at the base of the handset, but these interfaces typically have proprietary data protocol and electrical characteristics. For a PDA or PC to download data to one or more cellular phone, a special cable would need to be purchased. For each additional client, it is conceivable that more cables would be required. The use of the Internet removes this problem. It is now becoming common for devices to support connection to the Internet; via CDPD data over cellular radio frequencies, modem connection or Ethernet. If each device is already capable of connecting to the Internet, for general communication purposes, then the two devices effectively have a connection, so the need for additional cables between devices is removed. Any specialized hardware that is required becomes a shared resource connected to the server.

1. A method of enabling a consumer to program a first consumer electronics system (102) for operation according to a preference of the consumer, the method comprising enabling the consumer to interact via a network (112) with an application (114) on a server (110) for generating control data to program the first system according to the preference.

2. The method of claim 1 comprising enabling to download the control data from the server to the first system for programming the first system.

3. The method of claim 1 comprising enabling to download the control data from the server to a second system of the consumer for programming the first system upon transfer of the control data from the second system to the first system.

4. The method of claim 1, wherein the consumer interacts with the server via a second system (104) different from the first system.

5. The method of claim 1, wherein the operation relates to configuring the first system for selective processing of content information.

6. The method of claim 1, wherein the first system comprises at least one of the following: a PTV, an audio jukebox, a television set, a home entertainment system.

7. The method of claim 3, wherein the second system comprises at least one of the following: a set-top box; a PC; a telephone.

8. The method of claim 1, wherein the consumer is enabled to interact with the application via speech input.

9. The method of claim 8, wherein the consumer is enabled to specify the preference to a human operator who interacts with the application based on the user's input.

10. The method of claim 4, wherein the consumer interacts with the server through the second system from a location remote from the first system.

11. The method of claim 10, wherein consumer requests the server to establish contact with the first system and the server establishes the contact in response to the consumer's request.

12. The method of claim 1, wherein:
the server has a data base with information relating to the consumer and acquired prior to the interaction; and
the generation of the control data takes into account the information in the data base.

13. An electronic apparatus (300) for being configured by a consumer, the apparatus comprises a combination of a first consumer electronics system (102) and a second system (104), wherein:
the first system is programmable for operation according to a consumer's preference;
the second system is network-enabled for user-interaction via a data network (112) with an application server (110), the application server generating control data based on the consumer's preference for configuring the first system; and
the second system configures the first system based on the control data received from the server.

14. The apparatus of claim 13, wherein the first system comprises a PTV and the second system comprises a set-top box.

15. For use in a consumer electronics system, control data generated by an application server for configuring the system based on a preference specified by the consumer.
